(19) United States
(12) Patent Application Publication
(10) Pub. No.: US 2017/0361499 A1
(43) Pub. Date: Dec. 21, 2017

(54) AUTOMATIC VACUUM FILM TRANSFERRING MACHINE

(71) Applicant: HON HAI PRECISION INDUSTRY CO., LTD., New Taipei (TW)

(72) Inventors: HUNG-CHUN MA, New Taipei (TW); YU-LIN LIAO, New Taipei (TW); HAN-LUNG CHAO, New Taipei (TW); HUNG-LIEN YEH, New Taipei (TW); CHIH-JUNG CHANG, New Taipei (TW); JIH-CHEN LIU, New Taipei (TW); FENG-YUEN DAI, Tu-Cheng (TW)

(21) Appl. No.: 15/252,872

(22) Filed: Aug. 31, 2016

(30) Foreign Application Priority Data
Jun. 15, 2016 (TW) 105118665

(51) Int. Cl. B29C 31/00; B29C 59/00; B29C 59/02; B29L 7/00

(52) U.S. Cl. CPC B29C 31/006; B29C 59/022; B29C 59/002; B29L 2007/008

(57) ABSTRACT

A automatic vacuum film transferring machine includes an upper mold that can be driven to moved up and down; at least one lower mold each corresponding to the upper mold and configured to support a component to be transferred; a transferring support member located below the upper mold, and configured to support one lower mold; a first sliding support member and a second sliding support member each located on and driven to slide along two opposite side of the transferring support member, the first and second sliding support member are driven to dock onto the transferring support member to transfer one lower mold.

This application claims the benefit of priority under 35 USC 119 from Taiwan Patent Application 105118665, filed on Jun. 15, 2016.

### FIELD

The present disclosure relates to an automatic vacuum film transferring machine.

### BACKGROUND

Usually, a component is put on and taken away from a transferring mold by operation workers in a vacuum film transferring machine. This process is time consuming, costly, and burdensome. There is a need to automate a vacuum film transferring process for the component. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 illustrates an automatic vacuum film transferring machine in an original state according to an exemplary embodiment.

FIG. 2 illustrates the automatic vacuum film transferring machine of FIG. 1 in a feeding state according to the exemplary embodiment.

FIG. 3 illustrates the automatic vacuum film transferring machine of FIG. 1 in an unloading state according to the exemplary embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

An automatic vacuum film transferring machine includes: an upper mold driven to move up and down; at least one lower mold corresponding to the upper mold, the at least one lower mold configured to support a component to be transferred; a transferring support member being located below the upper mold, the transferring support member configured to support one lower mold; a first sliding support member being located on and driven to slide along one side of the transferring support member, the first sliding support member is able to dock onto the transferring support member to transfer one lower mold to the transferring support member; and a second sliding support member located on and driven to slide along an opposite side of the transferring support member, the second sliding support member is able to dock onto the transferring support member to transmit one lower mold from the transferring support member.

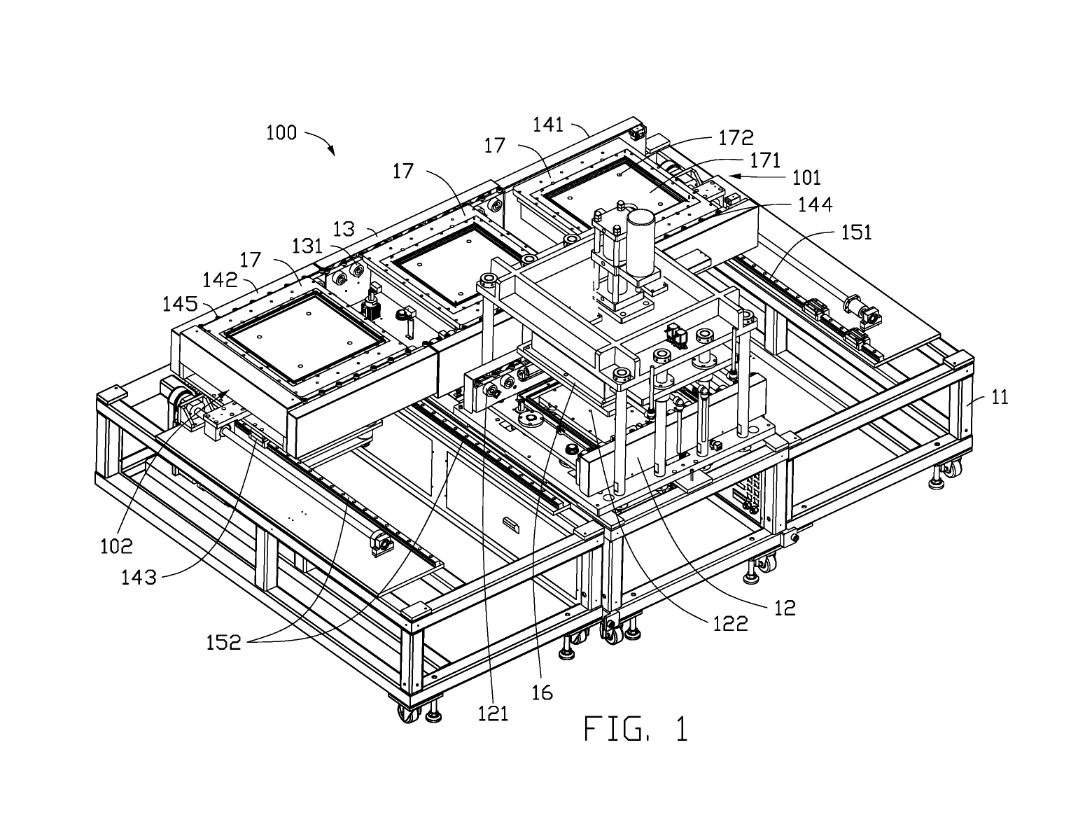

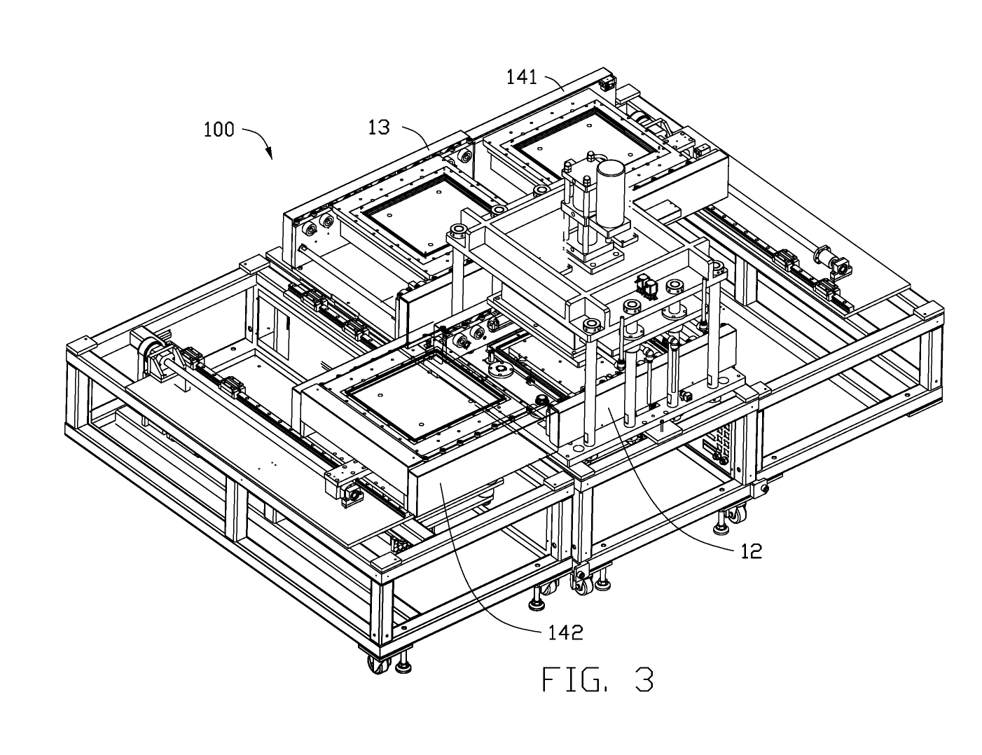

FIGS. 1 to 3 illustrate an exemplary embodiment of an automatic vacuum film transferring machine 100. The automatic vacuum film transferring machine 100 includes a machine platform 11, a transferring support member 12, a transition support member 13, a first sliding support member 141, a second sliding support member 142, a group of first sliding rails 151, a group of second sliding rails 152, an upper mold 16, and at least one lower mold 17.

The transferring support member 12 is fixed on the machine platform 11. The transferring support member 12 is configured to support a component to be transferred. In this embodiment, the transferring support member 12 is located on center of one side of the machine platform 11.

The transferring support member 12 defines a plurality of vacuum holes 122 to communicate with a vacuum pump (not shown). The transferring support member 12 includes a first transmission member 121. The first transmission member 121 is configured to transmit the lower mold 17 and is moved by the use of a driver (not shown). In this embodiment, the first transmission member 121 is a group of wheels, and can be rotated.

The transition support member 13 is also fixed on the machine platform 11. In this embodiment, the transition support member 13 is located on center of another side of the machine platform 11 and is opposite to the transferring support member 12. The transition support member 12 includes a second transmission member 131. The second transmission member 121 is also configured to transmit the lower mold 17 and is also moved by the use of a driver (not shown). In this embodiment, the second transmission member 131 is also a group of wheels, and can be rotated.

In this embodiment, the transition support member 13 docks onto the transferring support member 12. In other embodiments, the transition support member 13 may be separated from the transferring support member 12.

The first sliding support member 141 and the second sliding support member 142 are each located on opposite sides of the transition support member 13, and are each driven to slide by the use of a driver (not shown). A sliding direction of the first sliding support member 141 and a sliding direction of the second sliding support member 142 are each parallel to an arrangement direction of the transition support member 13 and the transferring support member 12, then the first sliding support member 141 and the second sliding support member 142 can each slide to locate on two opposite side of the transferring support member 12.

The first sliding support member 141 includes a third transmission member 144. The third transmission member 144 is also configured to transmit the lower mold 17 and is also moved by the use of a driver (not shown). In this embodiment, the third transmission member 144 is also a group of wheels, and can be rotated. The second sliding support member 142 includes a fourth transmission member 145. The fourth transmission member 145 is also configured to transmit the lower mold 17 and is also moved by the use of a driver (not shown). In this embodiment, the fourth transmission member 145 is also a group of wheels, and can be rotated.

In other embodiments, the first transmission member 121, the second transmission member 131, the third transmission member 144, and the fourth transmission member 145 can also be conveyor belts, or rollers.

In this embodiment, the first transmission member 121, the second transmission member 131, the third transmission member 144, and the fourth transmission member 145 have substantially the same height.

The group of first sliding rails and the group of second sliding rails are fixed on the machine platform. In this embodiment, the first sliding support member 141 and the second sliding support member 142 each includes a group of sliding grooves 143. The group of first sliding rails 151 is arranged in and corresponding to the group of sliding grooves 143 of the first sliding support member 141. The group of second sliding rails 152 is arranged in and corresponding to the group of sliding grooves 143 of the second sliding support member 142.

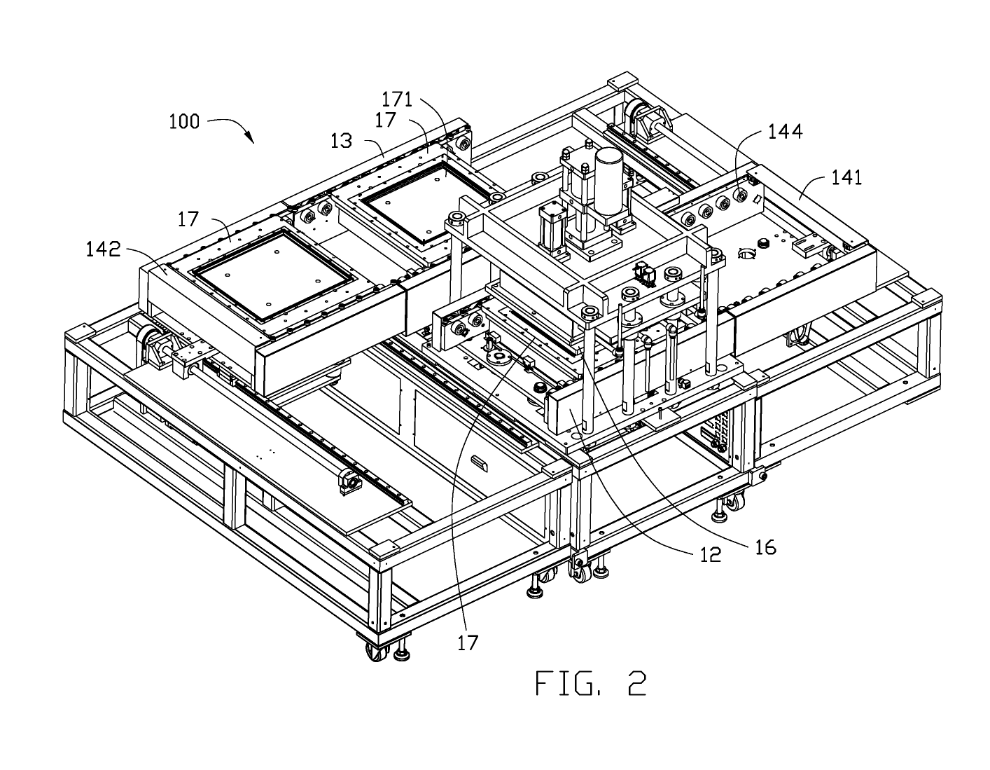

The automatic vacuum film transferring machine 100 includes a feeding portion 101 and an unloading portion 102 each respectively corresponding to opposite sides of the transition support member 142. The first sliding support member 141 and the second sliding support member 142 at least include an original state (shown in FIG. 1), a feeding state (shown in FIG. 2), and an unloading state (shown in FIG. 2). In the original state, the first sliding support member 141 and the second sliding support member 142 are each arranged on and docked to opposite sides of the transition support member 142 and correspond to the feeding portion 101 and an unloading portion 102. In the feeding state, the first sliding support member 141 may slide from one side of the transition support member 142 to one side of the transferring support member 12, and docks onto the transferring support member 12. In the unloading state, the second sliding support member 142 had slide from another side of the transition support member 142 to another side of the transferring support member 12, and docks onto the transferring support member 12.

The upper mold 16 is arranged above the transferring support member 12. The upper mold 16 can be heated by a heater (not shown), and can move up and down by a lifter (not shown). The upper mold 16 defines at least one image whereon.

Each lower mold 17 corresponds to the upper mold 16. Each lower mold 17 defines at least one cavity 171 and a plurality of mold vacuum holes 172 communicated with the cavity 171 and the vacuum holes 122. The lower mold 17 is configured to support a component. The lower mold 17 and the upper mold 16 are cooperatively configured to transfer the image of the upper mold 16 on a component.

In this embodiment, the number of the lower mold 17 is three. In the original state, three of the lower molds 17 are each respectively supported on the transition support member 13, the first sliding support member 141, and the second sliding support member 142.

In other embodiments, the upper mold 16 also can define a plurality of mold vacuum holes.

In other embodiments, the lower mold 17 can also define at least one image whereon.

In practice, the following steps may be included to operate the automatic vacuum film transferring machine 100.

S1, the first sliding support member 141 and the second sliding support member 142 are in the original state, and a component to be transferred is supported on the first sliding support member 141 through one lower mold 17.

S2, the first sliding support member 141 is driven to slide along the first sliding rail 151 to dock onto the transferring support member 12, then, the first sliding support member 141 and the second sliding support member 142 are in the feeding state.

S3, the lower mold 17 together with the component to be supported is positioned on the transferring support member 12 by the third transmission member 144 and the first transmission member 121 rotating cooperatively to transmit the lower mold 17.

S4, the first sliding support member 141 is driven to slide along the first sliding rail 151 to dock onto the transition support member 13 to return back to the original state.

S5, the upper mold 16 is driven down to contact with the lower mold 17. Then, the component to be transferred is heated by the upper mold 16, and then the component is transferred an image by a vacuuming process to form a transferred component.

S6, the lower mold 17 located on the transition support member 13 is positioned on the first sliding support member 141, and the lower mold 17 located on the second sliding support member 142 is positioned on the transition support member 13 by the second transmission 131, the third transmission member 144 and the fourth transmission member 145 rotate cooperatively to transmit the lower molds 17.

S7, the second sliding support member 142 is driven to slide along the second sliding rail 152 to dock onto the transferring support member 12, to place the first sliding support member 141 and the second sliding support member 142 are in the unloading state.

S8, the lower mold 17 together with the transferred component are positioned on the second sliding support member 142 by the first transmission member 121 and the fourth transmission member 145 rotating cooperatively to transmit the lower molds 17.

S9, the second sliding support member 142 is driven to slide along the second sliding rail 152 to dock onto the transition support member 13, to return to the original state.

Thereafter, S1 to S9 are repeated.

In other embodiments, S5 and S6 can be exchanged.

In other embodiments, S4 and S5 can be simultaneously with S6.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An automatic vacuum film transferring machine, comprising:
an upper mold, the upper mold capable of being driven to moved up and down;
at least one lower mold, wherein each of the at least one lower mold corresponds to the upper mold, the at least one lower mold is configured to support a component to be transferred, the lower mold and the upper mold are cooperatively configured to transfer an image on the component;
a transferring support member being located below the upper mold, the transferring support member being configured to support one lower mold;
a first sliding support member being located on and driven to slide along one side of the transferring support member, the first sliding support member is driven to dock onto the transferring support member and transmit one lower mold to the transferring support member; and
a second sliding support member located on and driven to slide along an opposite side of the transferring support member, the second sliding support member is driven to dock onto the transferring support member and to transmit one lower mold from the transferring support member.

2. The automatic vacuum film transferring machine of claim 1, further comprising a transition support member arranged on other side of the transferring support member, the transition support member being configured to support and transmit one lower mold, and, the first sliding support member and the second sliding support member are each driven to dock onto the two opposite sides of the transition support member.

3. The automatic vacuum film transferring machine of claim 2, wherein a sliding direction of the first sliding support member and a sliding direction of the second sliding support member are each parallel to an arrangement direction of the transition support member and the transferring support member.

4. The automatic vacuum film transferring machine of claim 2, further comprising a machine platform, the transition support member and the transferring support member are fixed on the machine platform.

5. The automatic vacuum film transferring machine of claim 4, further comprising a group of first sliding rails and a group of second sliding rails fixed on the machine platform, the first sliding support member slidably arranged on the group of first sliding rails, and the second sliding support member slidably arranged on the group of second sliding rails.

6. The automatic vacuum film transferring machine of claim 5, wherein the first sliding support member and the second sliding support member each includes a group of sliding grooves, the group of first sliding rails is arranged in and corresponding to the group of sliding grooves of the first sliding support member, the group of second sliding rails is arranged in and corresponding to the group of sliding grooves of the second sliding support member.

7. The automatic vacuum film transferring machine of claim 6, wherein the transferring support member includes a first transmission member, the transition support member includes a second transmission member, the first sliding support member includes a third transmission member, and the second sliding support member includes a fourth transmission member; the first transmission member, the second transmission member, the third transmission member, and the fourth transmission member are each respectively configured to support one lower mold and are each driven to transmit the lower mold.

8. The automatic vacuum film transferring machine of claim 7, wherein the first transmission member, the second transmission member, the third transmission member, and the fourth transmission member are respectively a group of wheels.

9. The automatic vacuum film transferring machine of claim 2, wherein the first sliding support member and the second sliding support member at least include an original state, a feeding state, and an unloading state; in the original state, the first sliding support member and the second sliding support member are each arranged on and docked to opposite sides of the transition support member; in the feeding state, the first sliding support member is driven to slide to dock with the transferring support member, in the unloading state, the second sliding support member is driven to slide to dock with the transferring support member.

10. The automatic vacuum film transferring machine of claim 2, wherein the number of the at least one lower mold is three.

11. The automatic vacuum film transferring machine of claim 1, wherein the transferring support member defines a plurality of vacuum holes.

12. The automatic vacuum film transferring machine of claim 11, wherein each lower mold defines at least one cavity communicated the vacuum holes, the at least one cavity is configured to receive a component to be transferred.

13. The automatic vacuum film transferring machine of claim 12, wherein each lower mold defines a plurality of mold vacuum holes to communicate the cavity and the vacuum holes of the transferring support member.
